(19) United States
(12) Patent Application Publication
(10) Pub. No.: US 2004/0094874 A1
(43) Pub. Date: May 20, 2004

(54) Method for making a composite construction panel

(76) Inventors: Lupe Estrada, Pomona, CA (US); Alberto Olivo, Pomona, CA (US)

Correspondence Address: Denton L. Anderson, Sheldon & Mak, 9th Floor, 225 South Lake Avenue, Pasadena, CA, 91101, US

(21) Appl. No.: 10/301,134

(22) Filed: Nov. 20, 2002

(51) Int. Cl. B29C 35/08

(52) U.S. Cl. 264/496; 264/308

(57) ABSTRACT

A method for making a composite construction panel includes at least the steps of (a) providing a mold, (b) applying a UV-curable gel coat to the mold, (c) directing UV radiation to the gel coat to cure the gel coat, (d) applying a first vail mat layer to the gel coat, (e) applying a first UV-curable wet out resin coat to the first vail mat layer, (f) directing UV radiation to the first wet out resin coat to cure the first wet out resin coat, (g) disposing a core material onto the first vail mat layer, (h) applying a second UV-curable wet out resin coat to the core material layer, (i) directing UV radiation to the second wet out resin coat to cure the second wet out resin coat and to thereby yield a composite construction panel, and (j) removing the composite construction panel from the mold.

### FIELD OF THE INVENTION

This invention relates generally to methods of making composites and, more specifically, to methods of making composite construction panels.

### BACKGROUND OF THE INVENTION

Composite materials have become very popular as substitutes for homogenous materials in a wide variety of applications. Composite construction panels, for example, are used as substitutes for construction panels made solely from a wood, a plastic or a metal.

One such composite construction panel comprises a core material and one or more resinous layers. Such composites have been found to be relatively easy and inexpensive to manufacture. One problem, however, with respect to the manufacture of such composites is the inordinate amount of time required in the manufacturing process. This is because each composite comprises several layers of resinous materials, each of which must be cured before the next step in the manufacturing process can be undertaken. The amount of time to cure each resinous layer is typically 8 to 24 hours. Thus, for a composite construction panel having three resinous layers, the total manufacturing time is typically 32 to 72 hours.

Accordingly, there is a need for a method for making composite construction panels which avoids this problem in the prior art.

### SUMMARY OF THE INVENTION

The invention satisfies this need. The invention is a method for making a composite construction panel. The method comprises the steps of (a) providing a mold, (b) applying a UV-curable gel coat to the mold, (c) directing UV radiation to the gel coat to cure the gel coat, (d) applying a first vail mat layer to the gel coat, (e) applying a first UV-curable wet out resin coat to the first vail mat layer, (f) directing UV radiation to the first wet out resin coat to cure the first wet out resin coat, (g) disposing a core material onto the first vail mat layer, (h) applying a second UV-curable wet out resin coat to the core material layer, (i) directing UV radiation to the second wet out resin coat to cure the second wet out resin coat and to thereby yield a composite construction panel, and (j) removing the composite construction panel from the mold.

### DESCRIPTION OF THE DRAWINGS

These and other features, aspects and advantages of the present invention will become better understood with reference to the following description, appended claims and accompanying drawings where:

FIG. 1 is a cross-sectional view of a mold carrying a completed composite construction panel manufactured by the method of the invention.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a method for making a composite construction panel 10. The method comprises the steps of (a) providing a mold 12, (b) applying a UV-curable gel coat 14 to the mold 12, (c) directing UV radiation to the gel coat 14 to cure the gel coat 14, (d) applying a first vail mat layer 16 to the gel coat 14, (e) applying a first UV-curable wet out resin coat (not shown) 18 to the first vail mat layer 16, (f) directing UV radiation to the first wet out resin coat to cure the first wet out resin coat, (g) disposing a core material 20 onto the first vail mat layer 16, (h) applying a second UV-curable wet out resin coat (not shown) to the core material layer 20, (i) directing UV radiation to the second wet out resin coat to cure the second wet out resin coat and to thereby yield a composite construction panel 10, and (j) removing the composite construction panel 10 from the mold 12.

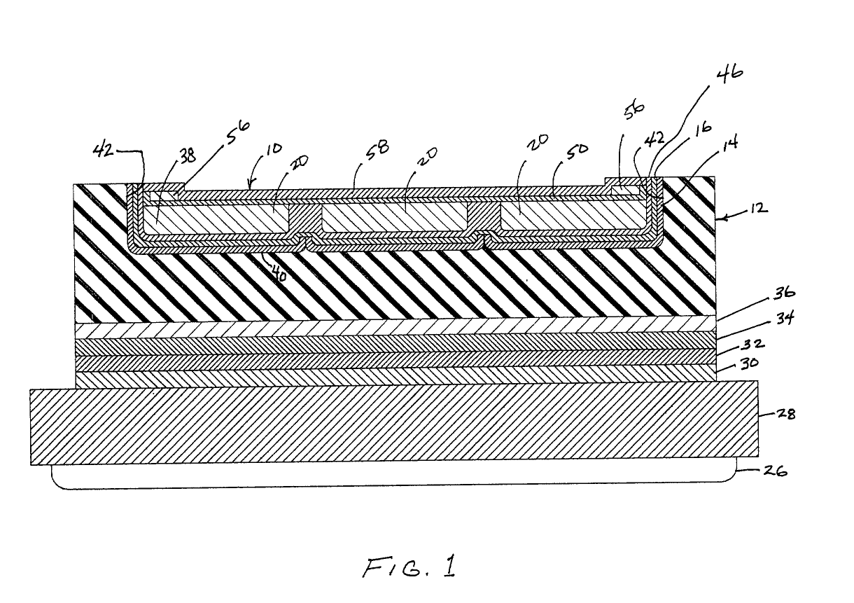

The mold 12 can be any of the many mold designs suitable for making composite construction panels. One such mold 12 is illustrated in FIG. 1. The mold 12 is made from silicone. It is supported on a base 24 comprising support members 26, such as 2×2 support members, a first plywood layer 28, such as a ¾ inch thick plywood layer, a second plywood layer 30, such as a ¼ inch plywood layer, two layers of fiberglass 32 and 34 and a layer of peg board 36.

The mold 12 defines a mold cavity 38 having the size and shape of the desired composite construction panel 10. In one typical embodiment, the mold cavity 38 has a rectangular bottom wall 40 which is about 77 inches long and about 34 inches wide and two pairs of opposed rectangular, vertical side walls 42, each about 3 inches in height.

The bottom wall 40 of the mold 12 typically defines the negative of a design which is desired in the finished composite construction panel 10. In a typical embodiment, such design can include the grain pattern of a wood, so that the finished composite construction panel 10 has the appearance of being made of wood. In such a case, the reverse of the grain pattern can be disposed within the bottom wall 40 of the mold 12 by pressing sheets of wood against the bottom wall 40 of the mold 12 before the silicone material in the bottom wall 40 is fully hardened.

Once the mold 12 has been provided, it can be repeatedly used to form composite construction panels 10.

An optional first step in the method of the invention is to apply a UV-curable clear coat (not shown) to the mold. The clear coat is typically a clear resin, for example, a clear resin comprising about 10 wt. % methyl methacrylate, about 35 wt. % styrene monomer and 10-60 wt. % unsaturated polyester resin.

Where a clear coat is used in the method of the invention, it is very important that the clear coat be a material which is UV-curable. The term “UV-curable” as used throughout this application means that a coating of the material (which has been modified by the term “UV-curable”) can be cured in less than about 6 minutes by being subjected to UV radiation, preferably cured in less than about 3 minutes. In the case of the clear coat, it is preferable that the clear coat be curable by UV radiation in less than about 6 minutes. One UV-curable clear coat useable in the invention is a product sold by Cook Composites and Polymers Co. of North Kansas City, Mo., under the product designation Polycor 942XA220.

The next step in the method of the invention is to apply a UV-curable gel coat 14. Where a clear coat has been used, the gel coat 14 is applied to the clear coat. In embodiments of the method where no clear coat has been used, the gel coat 14 is applied directly to the mold 12. The gel coat 14 provides the color of the finished composite construction panel 10. Gel coats 14 useable in the method are typically clear or colored thixotropic, neopentyl glycol isothalic polyesters suitable for spray applications.

Like the clear coat, it is important that the gel coat 14 material be a material which is a UV-curable. In this regard, it is preferable that the gel coat 14 be cured by UV-radiation in less than about 6 minutes.

One gel coat 14 material which is useable in the invention is a material marketed by AOC, L.L.C. of Colierville, Tenn., under the product designation Vibrin Ultraviolet Initiated Gel Coat.

The next step in the method of the invention is to apply a first vail mat layer 16 to the gel coat 14. The first vail mat layer 16 is typically a continuous filament glass fiber mat for plastic reenforcement. Such continuous filament glass fiber mats are commonly made from E Glass having a relatively low alkaline content. A typical vail mat useable in the invention can be purchased from Saint-Gobain Vetrotex International, S.A. of Midland, Ontario, Canada.

Once the first vail mat layer 16 has been applied to the gel coat 14, a first UV-curable wet-out resin is applied to the first vail mat layer 16. The first wet-out resin coat is typically a medium reactive, non-thick thixotropic, UV-initiated, pre-promoted resin design for use in the fabrication of composite parts using spray or hand lay-up methods.

It is important that the first wet-out resin coat be a material which is UV-curable. In this regard, it is preferable that the first wet-out resin coat be of a material which can be cured by UV-radiation in less than about 6 minutes.

One UV-curable wet-out resin useable in the invention is a material sold by L.L.C. of Colierville, Tenn., under the product designation RayCure Ultraviolet Initiated Orthophthalic Laminating Resin.

After the first wet-out resin coat has been applied to the first vail mat layer 16, the first wet-out resin coat and the first vail mat layer 16 are smoothed out. The use of hand-held rollers can be effective in this regard.

After the first wet-out resin coat is cured, an optional second vail mat layer 46 can be applied to the first wet-out resin coat. The second vail mat layer 46 can be identical to the first vail mat layer 16.

After the second vail mat layer 46 has been applied to the first wet-out resin coat 18, a UV-curable second wet-out resin coat (not shown) is applied to the second vail mat layer 46. The second wet-out resin coat can be identical to the first wet-out resin coat. Like the first wet-out resin coat, it is important that the second wet-out resin coat is UV-curable. Like the first wet-out resin coat, it is important that the second wet-out resin coat be curable by UV-radiation in less than about 6 minutes.

After the second wet-out resin coat has been applied to the second vail mat layer 46, the second wet-out resin coat and the second vail mat layer 46 are smoothed out. After being smoothed out, the second wet-out resin coat is cured using UV radiation. As is the case with all of the wet out resin coats used in the invention, the cure time for the second wet out resin coat is typically less than about 6 minutes, most typically between about 1 minutes and about 3 minutes.

The next step in the method of the invention is to dispose a first core material layer 20 into the mold 12. Where a second vail mat layer 46 has been used, the first core material layer 20 is disposed onto the second wet-out resin coat. Where no second vail mat layer 46 has been used, the first core material layer 20 is disposed onto the first wet-out resin coat. The first core material 20 can be any suitable core material which can impart to the composite construction panel 10 sufficient strength for the composite construction panel 10 to be useable for its intended purpose. The first core material 20 should also be relatively light in weight and relatively inexpensive. Wood slats can be used as the core material, as can peg board. A preferable core material is an extruded polypropylene honeycomb in sheet form with a surface covering of non-woven polyester fabric and polypropylene film fusion bonded to both sides of the sheet. One such polypropylene honeycomb can be purchased from Nida-Core Corp. of Palm City, Fla., under the product designation Nida-Core H8PP Honeycomb.

Next, an optional additional vail mat layer 50 is applied to the first core material layer 20. The additional vail mat layer 50 can be identical to the first vail mat layer 16.

In cases where no vail mat layer 50 is applied to the first core material layer 20, a first core material wet-out resin coat (not shown) is applied to the first core material layer 20. The first core material wet-out resin coat can be identical to the first wet-out resin coat 16. Like the first wet-out resin coat 16, the first core material wet-out resin coat is UV-curable, preferably curable by UV radiation in less than about 6 minutes. After the first core material wet-out resin coat has been applied to the first core material layer 20, the first core material wet-out resin coat is cured by applying UV-radiation to the wet-out resin coat.

In cases where the optional additional vail mat layer 50 is applied to the first core material 20, an additional vail mat layer wet-out resin coat (not shown) is applied to the additional vail mat layer 50. Like the previously described wet-out resin coats, the additional vail mat layer wet-out resin coat is a UV-curable wet-out resin coat, preferably one which can be cured by UV-radiation in less than about 6 minutes. The additional vail mat layer wet-out resin coat can be made of a material identical to that used for the first wet-out resin coat.

In cases where an additional vail mat layer 50 is applied to the first core material layer 20, the additional vail mat layer 50 and the additional vail mat wet-out resin coat are smoothed and the additional vail mat wet out resin coat is then cured by UV-radiation.

In cases where an additional vail mat layer 50 is applied to the first core material layer 20, an optional second core material layer 56 can be applied to the additional vail mat layer 50. This optional second core material layer 56 can be made from a material identical to the first core material layer 20.

In cases where a second core material layer 56 is used, an optional second core material vail mat layer 58 can be applied to the second core material layer 56. If such second core material vail mat layer 58 is applied, a second core material vail mat wet-out resin layer (not shown) is applied to the second core material vail mat layer 58. Like previously discussed wet-out resin coats, the second core material vail mat wet-out resin coat is preferably UV-curable such that the second core material vail mat wet-out resin coat can be cured by UV-radiation in less than about 6 minutes. The second core material vail mat wet-out resin coat can be made from a material identical to the first wet-out resin coat described above.

In cases where a second core material vail mat layer 58 is used, the second core material vail mat layer 58 and the second core material wet-out resin coat are smoothed and then the second core material wet out resin coat is cured using UV-radiation.

In cases where a second core material vail mat layer 58 is not applied to the second core material layer 56, the second core material wet-out resin coat is applied directly to the second core material layer 56.

Once the last wet-out resin coat is cured, the finished composite construction panel 10 is removed from the mold.

The UV-radiation used to cure the clear coats, the gel coats and each of the wet-out resin coats can be provided by standard UV-lamps known in the industry. One such UV-lamp is provided by fusion UV Systems, Inc. of Gaithersburg, Md., under the product designation Fusion Ultraviolet Lamp System F300S/F300SQ. Each fusion UV-lamp system generates microwaves energy at 2450 MHZ in the 200-400 nanometer region. Typically, four such lamps are used to cure each curable layer in the method. Additional layers can be used for faster curing times.

The method provides a simple and inexpensive method to make composite construction panels in a fraction of the time previously required.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A method for making a composite construction panel, the method comprising the steps of:
(a) providing a mold;
(b) applying a UV-curable gel coat to the mold;
(c) directing UV radiation to the gel coat to cure the gel coat;
(d) applying a first vail mat layer to the gel coat;
(e) applying a first UV-curable wet out resin coat to the first vail mat layer;
(f) directing UV radiation to the first wet out resin coat to cure the first wet out resin coat;
(g) disposing a core material onto the first wet-out resin coat;
(h) applying a second UV-curable wet out resin coat to the core material layer;
(i) directing UV radiation to the second wet out resin coat to cure the second wet out resin coat and to thereby yield a composite construction panel; and
(j) removing the composite construction panel from the mold.

2. The method of claim 1 wherein the gel coat is cured in less than about 6 minutes.

3. The method of claim 1 wherein the first wet-out resin coat is cured in less than about 6 minutes.

4. The method of claim 1 wherein the second wet-out resin coat is cured in less than about 6 minutes.

5. The method of claim 1 further comprising the step of, before applying a UV-curable gel coat in step (b), applying a UV-curable clear coat to the mold and directing UV radiation to the clear coat to cure the clear coat.

6. The method of claim 5 wherein the clear coat is cured in less than about 6 minutes.

7. The method of claim 1 further comprising the steps of, after curing the first wet out resin coat in step (f), applying a second vail mat layer to the first wet out resin coat, applying a third UV-curable wet out resin coat to the second vail mat layer and disposing the core material layer in step (g) onto the second vail mat layer.

8. The method of claim 7 wherein the third UV-curable wet-out resin is cured in less than about 6 minutes.

9. The method of claim 1 further comprising the step of applying a second vail mat layer to the core material and applying the second UV-curable wet out resin coat in step (h) to the second vail mat layer.

10. A method for making a composite construction panel, the method comprising the steps of:
(a) providing a mold;
(b) applying a UV-curable clear coat to the mold;
(c) directing UV radiation to the clear coat to cure the clear coat;
(d) applying a UV-curable gel coat to the clear coat;
(e) directing UV radiation to the gel coat to cure the gel coat;
(f) applying a first vail mat layer to the gel coat;
(g) applying a first UV-curable wet out resin coat to the first vail mat layer;
(h) directing UV radiation to the first wet out resin coat to cure the first wet out resin coat;
(i) applying a second vail mat layer to the first wet out resin coat;
(j) applying a second UV-curable wet out resin coat to the second vail mat layer;
(k) disposing a core material onto the second wet-out resin coat;
(l) applying a third vail mat layer to the core material layer;
(m) applying a third UV-curable wet out resin coat to the third vail mat layer;
(n) directing UV radiation to the third wet out resin coat to cure the third wet out resin coat to thereby yield a composite construction panel; and
(o) removing the composite construction panel from the mold.

11. The method of claim 10 further comprising the step of, after curing the third wet-out resin coat, disposing a second core material layer to the third wet-out resin coat, applying a fourth vail mat layer to the third wet-out resin coat, applying a fourth UV-curable wet-out resin to the fourth vail mat layer and directing UV-radiation to the fourth wet-out resin coat to cure the fourth wet-out resin coat.

12. A method for making a composite construction panel, the method comprising the steps of:
(a) providing a mold;
(b) applying a UV-curable clear coat to the mold;
(c) directing UV radiation to the clear coat to cure the clear coat in less than about 6 minutes;
(d) applying a UV-curable gel coat to the clear coat;
(e) directing UV radiation to the gel coat to cure the gel coat in less than about 6 minutes;
(f) applying a first vail mat layer to the gel coat;
(g) applying a first UV-curable wet out resin coat to the first vail mat layer;
(h) directing UV radiation to the first wet out resin coat to cure the first wet out resin coat in less than about 6 minutes;
(i) applying a second vail mat layer to the first wet out resin coat;
(j) applying a second UV-curable wet out resin coat to the second vail mat layer;
(k) disposing a core material layer onto the second wet-out resin coat;
(l) applying a third vail mat layer to the core material layer;
(m) applying a third UV-curable wet out resin coat to the third vail mat layer;
(n) directing UV radiation to the third wet out resin coat to cure the third wet out resin coat in less than about 6 minutes and to thereby yield a composite construction panel; and
(o) removing the composite construction panel from the mold.

13. The method of claim 12 further comprising the step of, after curing the third wet-out resin coat, disposing a second core material layer to the third wet-out resin coat, applying a fourth vail mat layer to the third wet-out resin coat, applying a fourth UV-curable wet-out resin to the fourth vail mat layer and directing UV-radiation to the fourth wet-out resin coat to cure the fourth wet-out resin coat.
